(19) United States
(12) Patent Application Publication
(10) Pub. No.: US 2025/0091538 A1
(43) Pub. Date: Mar. 20, 2025

(54) SELF-CONTAINED VOICE CONTROL SYSTEM FOR RV

(71) Applicant: Cheng USA, Inc., San Francisco, CA (US)

(72) Inventor: Jack Shihkun Cheng, San Francisco, CA (US)

(73) Assignee: Cheng USA, Inc., San Francisco, CA (US)

(21) Appl. No.: 18/887,280

(22) Filed: Sep. 17, 2024

Related U.S. Application Data
(60) Provisional application No. 63/539,414, filed on Sep. 20, 2023.

(51) Int. Cl. B60R 16/037; B60H 1/00; B60P 3/34; B60Q 11/00; G06F 3/16; G10L 15/08; G10L 15/22

(52) U.S. Cl. CPC B60R 16/0373; B60Q 11/005; G06F 3/167; G10L 15/08; G10L 15/22; B60H 1/00757; B60P 3/34; G10L 2015/088; G10L 2015/223

(57) ABSTRACT

A self-contained, voice-controlled system for a vehicle is provided, comprising: a control panel having a first microphone for receiving voice commands from a user; a remote interface in communication with the control panel, the remote interface having a second microphone for receiving voice commands from the user; and a power module in communication with the control panel and configured to provide an activation signal to a controlled component of the vehicle in response to receipt of a valid voice command from the user. A processor of the control panel determines whether a received voice command is a valid voice command by accessing instructions stored on a memory of the control panel.

### CROSS-REFERENCE TO RELATED APPLICATION

This application claims priority to U.S. Provisional Application No. 63/539,414, filed Sep. 20, 2023, which is hereby incorporated by reference in entirety for all purposes.

### FIELD

The present disclosure pertains to control systems, and in particular to self-contained control systems with voice control capability for vehicles such as recreational vehicles.

### BACKGROUND

A variety of different types of vehicles are known that may be driven or towed for use as storage and/or living space such as, but not limited to, motorhomes (class A, B, or C), truck campers, camper vans, pop-up campers, fifth wheel travel trailers, towable or motorized toy haulers, recreational utility vehicles, etc. (collectively referred to herein as “recreational vehicles” or “vehicles”). In many instances, these recreational vehicles include a plurality of components to enable and/or enhance the functions and comfort of the vehicle, such as automated space expansion components, heating, air conditioning and plumbing components, power and lighting components, and locking components, among others. In certain vehicles, such components may be operated individually, using separate switches or other controls. However, it is desirable to permit the user of the recreational vehicle to control such components, as well as monitor certain operational parameters of such components, from a central controller.

Even in vehicles that provide centralized control of controllable components, the user must move to the centralized controller and directly interact with it, such as by pressing buttons, etc. It is desirable to provide voice control of a centralized controller to permit the user to interact with the system from a distance. Moreover, as recreational vehicles are frequently used in remote locations with poor or no access to the internet, it is desirable to provide a voice controlled centralized controller that operates independent of the internet or other networks. Finally, it is desirable to provide such a self-contained, voice control system that may also be controlled by a remote interface such as a smart phone running an app to permit the user to control and/or monitor the components of the vehicle from outside the vehicle or from some other remote location.

### SUMMARY

According to one embodiment of the present disclosure, a control system for a vehicle is provided, comprising: a power distribution center; and a controller in communication with a plurality of controlled components of the vehicle, the controller including: a power module configured to receive power from the power distribution center, the power module including a plurality of output drivers, each of the plurality of output drivers being in communication with a corresponding one of the plurality of controlled components; a user interface configured to receive voice commands from a user; a memory including instructions for responding to received voice commands; and a processor coupled to the user interface and the memory and configured to execute the instructions in response to the received voice commands by providing at least one command to the power module to provide an activation signal via one or more of the plurality of output drivers to a corresponding one or more of the plurality of controlled components. In one aspect of this embodiment, the user interface includes one or more microphones for receiving the voice commands. In another aspect, the controller is configured to operate in a stand by mode, wherein the user interface listens for a wake-up word from the user, the controller being configured to respond to a wake-up word by entering a control mode. In a variant of this aspect, the wake-up word is configured by the user. In another variant, the user interface is configured to only receive voice commands when the controller is in the control mode. Another aspect of this embodiment further comprises a remote interface in communication with the controller, the remote interface being configured to receive voice commands from the user. In a variant of this aspect, the remote interface is in communication with the controller over a short-range wireless connection. Another aspect of this embodiment further comprises a brake light sensor coupled to the controller, the brake light sensor being configured to respond to detection of power to a brake light of the vehicle by providing a signal to the controller which causes the controller to disable activation of at least one of the plurality of controlled components. In a variant of this aspect, the user interface includes a button that permits the user to re-enable activation of the at least one of the plurality of controlled components. In yet another aspect, the plurality of controlled components includes at least two of a slide out, an awning, a water pump, a water heater, an HVAC system, a door lock and a plurality of lights. Another aspect further comprises a plurality of monitored components of the vehicle, the controller being in communication with the plurality of monitored components and configured to receive information from the plurality of monitored components, the user interface being configured to display the information to the user. In a variant of this aspect, the information relates to a status and/or an operational parameter of at least one of the plurality of monitored components. In another variant, the plurality of monitored components includes at least two of a fresh water tank, a black water tank, a gray water tank, a tire pressure sensor, a propane tank, a battery, an AC power input, an interior thermostat and an exterior thermostat. In yet another aspect of this embodiment, the user interface further includes a speaker, the controller being configured to respond to received voice commands by providing information to the user via the speaker. In another aspect, the plurality of controlled components includes a plurality of lights, the controller being configured to permit the user to define a plurality of lighting scenes, each lighting scene corresponding to at least one of a color or intensity setting of each of the plurality of lights. In a variant of this aspect, the controller is configured to permit the user to control a set of lights of the plurality of lights by providing a voice command corresponding to a name of the set of lights.

In another embodiment, the present disclosure provides a self-contained, voice-controlled system for a vehicle, comprising: a control panel having a first microphone for receiving voice commands from a user; a remote interface in communication with the control panel, the remote interface having a second microphone for receiving voice commands from the user; and a power module in communication with the control panel and configured to provide an activation signal to a controlled component of the vehicle in response to receipt of a valid voice command from the user; wherein a processor of the control panel determines whether a received voice command is a valid voice command by accessing instructions stored on a memory of the control panel. One aspect of this embodiment further comprises a brake light sensor coupled to the control panel, the brake light sensor being configured to respond to detection of power to a brake light of the vehicle by providing a signal to the control panel which causes the processor to prevent the power module from providing the activation signal to the controlled component. In another aspect, the control panel is configured to operate in a stand by mode, wherein the control panel listens for a wake-up word from the user, the controller being configured to respond to a wake-up word by entering a control mode.

In yet another embodiment, the present disclosure provides a system for controlling the operation of components of a vehicle, comprising: a controller in communication with a plurality of controlled components of the vehicle, the controller including a user interface configured to receive voice commands from a user, and a processor coupled to the user interface and configured to respond to the received voice commands by causing the controller to provide an activation signal to at least one of the plurality of controlled components; and a brake light sensor coupled to the controller, the brake light sensor being configured to respond to detection of power to a brake light of the vehicle by providing a signal to the controller which causes the processor to disable activation of at least one of the plurality of controlled components.

### BRIEF DESCRIPTION OF THE DRAWINGS

The above-mentioned and other advantages and objects of this disclosure, and the manner of attaining them, will become more apparent, and the disclosure itself will be better understood, by reference to the following description of embodiments of the invention taken in conjunction with the accompanying drawings, wherein:

FIG. 1 is a schematic diagram of components of a system according to one embodiment of the present disclosure.

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

In general, the present disclosure provides a control system for operating accessories on a recreational vehicle or other similar vehicles. The control system uses voice recognition software and does not require an internet connection.

The system is able to control several devices or components including lights, water pumps, water heaters, heaters, ventilation systems, air conditioning, and door locks. The system can also monitor and announce the status of water tanks, propane tanks, and the battery power source.

The system includes connection with remote user interface devices such as tablets, smart phones or other similar devices. This allows both voice and touch remote control of all functions.

As is further described below, the control system includes two main components, the control panel, which comprises status indicators, pushbuttons, a microphone and a speaker, and the power switching module, which comprises the monitor inputs and the control output connections.

The controlled outputs include all of the devices that the system can control. The monitor inputs include the signal sources that the system can monitor.

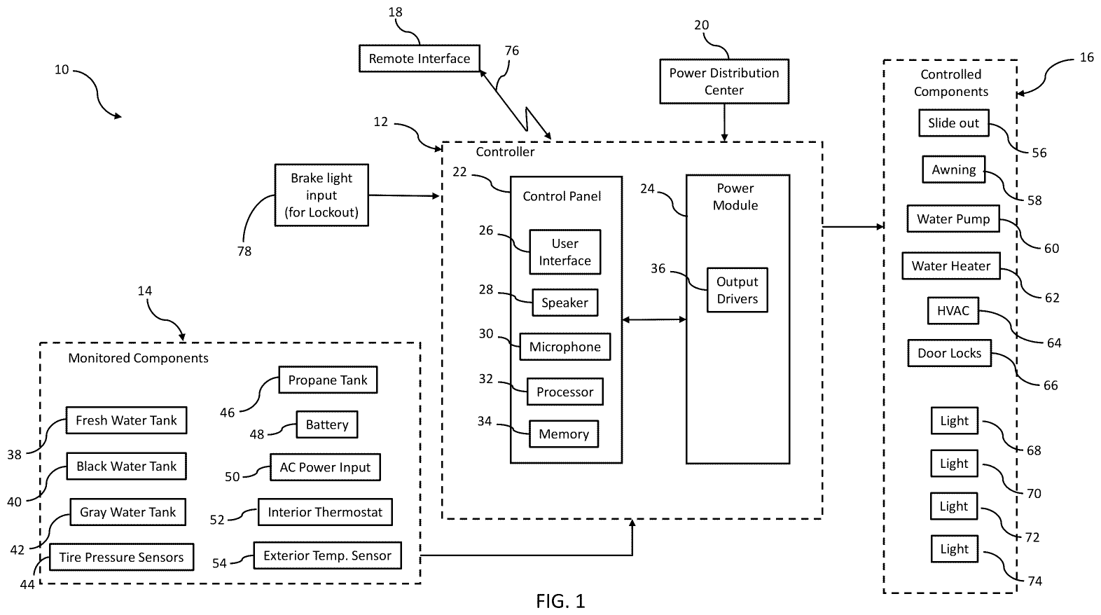

Referring now to FIG. 1, a control system 10 for a recreational vehicle or other similar type of vehicle according to one embodiment of the present disclosure is shown. The control system 10 generally includes a controller 12, a plurality of monitored components 14, a plurality of controlled components 16, a remote interface 18, a power distribution center 20 and a brake light input 78. The controller 12 generally includes a control panel 22 and a power module 24. The control panel 22 includes a user interface 26, a speaker 28, a microphone 30, a processor 32 and a memory 34. The power module 24 includes a plurality of output drivers 36.

The plurality of monitored components 14 may include, but is not limited to, a fresh water tank 38, a black water tank 40, a gray water tank 42, a plurality of tire pressure sensors 44, a propane tank 46, a battery 48, an AC power input 50, an interior thermostat 52 and an exterior temperature sensor 54. The plurality of monitored components 14 may include more or fewer components in other applications of the control system 10. The battery 48 may be any suitable energy storage device or plurality of devices. Each of the monitored components 14 includes at least one sensor or indicator that is configured to provide information about at least one operational parameter of the monitored component 14 to the power module 24.

The plurality of controlled components 16 may include, but is not limited to, one or more slide out 56, one or more awning 58, one or more water pump 60, one or more water heater 62, an HVAC system 64, a plurality of door locks 66, and a plurality of lights 68, 70, 72, 74. The plurality of controlled components 16 may include more or fewer components in other applications of the control system 10. As is known in the RV industry, many vehicles are equipped with expandable living space such as slide out rooms or portions of rooms (i.e., slide out 56) that may be extended outwardly from the vehicle during use and retracted while the vehicle is traveling. Each of the controlled components 16 includes an actuator (e.g., a motor) and/or a controller which is in communication with the output drivers 36 of the power module 24 and configured to control operation of at least one function of the controlled component 16.

The remote interface 18 may be a smart phone, a tablet, a laptop, a personal computer or any other similar mobile computing device. As shown, the remote interface 18 may communicate with the controller 12 over a wireless connection 76 using, for example, a short range wireless communication standard such as, but not limited to, Bluetooth. In alternative embodiments, wireless connection 76 may be replaced with a wired connection, a personal area network, or other type of connection. As is further described herein, the remote interface 18 includes user I/O capability such as via a touch screen, buttons, and/or voice control. The remote interface 18 includes a variety of other components which enable communications with controller 12, for example, which are known and not described herein to simplify the description.

The power distribution center 20 provides the power to operate the control panel 12 and the output drivers 36 of the power module 24. The power distribution center 20 may be connected to the battery 48 and/or the AC power input 50 to receive input power for distribution to the control panel 12 and power module 24 as well as other components of the vehicle.

The brake light input 78 is coupled to a power line to one or more brake lights of the vehicle to detect when the brake has been activated by a driver of the vehicle. When the brake is activated, the brake light input 78 senses the power to the brake light and provides a signal to the controller 12. The controller 12 causes the control panel 22 to discontinue operation and disable activation of at least some of the controlled components 16 such as, but not limited to, the slide out 56, the awning 58, and the water pump 60. This provides a safety feature of preventing operation of motorized functions of the vehicle while the vehicle is or could be in motion. The user may unlock the functions of the control panel 22 to permit operation of the controlled components 16 by pressing one or more unlock buttons on the user interface 26 of the control panel 22. Alternatively, the unlock button may be displayed on the remote interface 18.

The user interface 26 may include a touch screen, a plurality of physical buttons, a display, one or more indicators, or any other device that facilitates user input and output. The speaker 28 may be part of the user interface 26 or a separate component. The speaker 28 may also be located remotely relative to the control panel 22 elsewhere on the vehicle. In alternative embodiments, a speaker 28 may be part of the control panel 22 and one or more additional speakers may be located elsewhere on the vehicle. As is further described herein, the speaker 28 may be used to provide information, such as statuses, alerts, prompts, responses, etc., to the user. The microphone 30 may similarly be part of the user interface 26 or a separate component. The microphone 30 may also be located remotely relative to the control panel 22 elsewhere on the vehicle. In alternative embodiments, a microphone 30 may be part of the control panel 22 and one or more additional microphones may be located elsewhere on the vehicle. As is further described herein, the microphone 30 may be used to receive information, such as commands, etc., from the user.

The processor 32 of the control panel 22 may form a portion of a processing subsystem including one or more computing devices having memory, processing, and communication hardware. The processor 32 may be a single device or a distributed device, and the functions of the processor 32 may be performed by hardware and/or as computer instructions on a non-transient computer readable storage medium, such as the memory 34. The memory 34 may include one or more memory devices that functions to store information and instructions that are used and/or executed by the processor 32. For example, the computer instructions or programming code in the memory 34 may be implemented in any viable programming language such as C, C++, HTML, XTML, JAVA or any other viable high-level programming language, or a combination of a high-level programming language and a lower-level programming language. The instructions stored in the memory 34, when executed by the processor 32, cause the control system 10 to perform the various functions described herein.

The power module 24 may also include a processor, a communications interface for communications with the power distribution center 20, the control panel 22, and/or the monitored components 14 in addition to the output drivers 36. The output drivers 36 may be implemented using analog and/or digital circuits. The power module 24 is connected to the plurality of monitored components 14 to receive status signals from the monitored components 14 that indicate one or more operational parameters of the monitored components 14. The power module 24 is also connected to the control module 22 to provide the status of the various monitored components 14, which may be communicated to the user via the user interface 26, the remote interface 18, and/or the microphone 30. As is further described herein, the output drivers 36 of the power module 24 are configured to respond to commands from the processor 32 of the control panel 22 by providing activation signals to one or more of the controlled components 16.

In operation, the controller 12 normally remains in a stand-by mode, wherein the controller 12 may monitor the monitored components 14 and even display information about their operational status. While in stand-by mode, the microphone 30 of the control panel 22 and/or a microphone on the remote interface 18 continuously listens for a wake-up word from the user followed by a command. In certain embodiments, the user may configure or customize the wake-up word to be recognized by the control panel 22. After detecting the wake-up word, the controller 12 enters a control mode, wherein the control panel 22 waits for a phrase from the user that corresponds to a valid command. By way of example, the user may say “RV, raise the awning,” where “RV” is the wake-up word and “raise the awning” is the command. Continuing this example, the control panel 22 would respond to the command “raise the awning” by providing a control signal to the power module 24 to activate an output driver 36 with power from the power distribution center 20. The output driver 36 in this example is connected to a motor coupled to the awning 58. The activation signal from the output driver 36 causes the motor to move the awning 58 toward a raised position. The control module 22 may also respond to the command by providing a visual response to the user on the user interface 26 and/or the remote interface 18 and/or an audible response to the user via the microphone 30 to confirm that the command was properly interpreted and is being executed. In certain embodiments, the audible response may be conversational (e.g., “the awning is being raised”) or simply a sound or tone. In other embodiments, responses to the user may address the user using a user-defined nickname. In the above example, such a personalized response may be “Mike, the awning is being raised.”

The speech recognition software and operation logic stored in the memory 34 and executed by the processor 32 is locally programmed into the control panel 22 to allow for complete off-line independent operation. In other words, no internet connection or other connection to a network is required. In addition to operations of the control system 10 being controlled by the control panel 22 with push buttons and/or voice commands, there is an associated software application that can be operated on the remote interface 18. In certain embodiments, this software application provides both touch control and voice control capability as well as monitoring functions for the user as described herein.

Thus, the control system 10 generally permits voice or touch inputs from the user from the user interface 26, the microphone 30 and/or the remote interface 18 to control a plurality of functions of the controlled components 16. Using any of these input means, the user may cause the control panel 22 to command the power module 24 to extend and/or retract the one or more slide outs 56, raise and/or lower the one or more awnings 58, activate and/or deactivate the one or more water pumps 60, activate, deactivate and/or change the set temperature and/or a schedule of the one or more water heaters 62, activate, deactivate and/or change the set temperature and/or a schedule of the HVAC system 64, activate and/or deactivate the one or more door locks 66, and activate and/or deactivate the plurality of lights 68, 70, 72, and 74. As indicated above, the control system 10 may also interact with the user to provide confirmation of valid commands and/or prompts for additional commands, etc.

The control system 10 also generally provides information to the user regarding the plurality of monitored components 14 via the user interface 26, the speaker 28 and/or the remote interface 18. Using any of these output means, the control system 10 may provide the user with the operational status of the plurality of monitored components 14 such as by indicating the levels of the fresh water tank 38, the black water tank 40, the gray water tank 42, and/or the propane tank 46. The control system 10 may also provide alerts to the user when a level of one or more of these components is approaching a threshold corresponding to an unacceptably low level and/or an unacceptably high level. The control system 10 may also provide the user with the status and/or state-of-health of the battery 48 (e.g., level of charge remaining), and/or alerts when the state-of-health of the battery 48 approaches a threshold corresponding to an unacceptably low charge. Similarly, the control system 10 may provide the user with information regarding the AC power input 50, indicating the voltage, power quality and/or other parameters. The control system 10 also may provide the user with information regarding the performance of the interior thermostat 52 and the exterior temperature sensor 54, such as the current temperature inside and outside the vehicle. The control system 10 may also provide the current air pressure in each of the vehicle tires as sensed by the tire pressure sensors 44, as well as alerts when the tire pressure in a tire approaches an unacceptably low pressure.

The control system 10 of the present disclosure may also allow the user to customize certain functions in addition to those described above. For example, using any of the input means described above, the user may adjust the color and/or intensity of any of the lights 68, 70, 72, and 74. Additionally, the user may create light zones or scenes such as a relaxed scene (e.g., all lights on low intensity blue) or a party scene (e.g., all lights changing color and intensity), and store the scenes under user-defined names for later recall. Moreover, the user may name different sets of lights using the control system 10 (e.g., light 68 and 70 are “rear lights” and light 72 and 74 are “front lights”), and define corresponding commands to control sets of lights rather than individual lights.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counterclockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at various times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single device or geographic location (e.g., within a home environment, an office environment, or a server farm). In other example embodiments, the one or more processors or processor-implemented modules may be distributed across a number of devices or geographic locations.

Unless specifically stated otherwise, use herein of words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Additionally, some embodiments may be described using the expression “communicatively coupled,” which may mean (a) integrated into a single housing, (b) coupled using wires, or (c) coupled wirelessly (i.e., passing data/commands back and forth wirelessly) in various embodiments.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A control system for a vehicle, comprising:
a power distribution center; and
a controller in communication with a plurality of controlled components of the vehicle, the controller including:
a power module configured to receive power from the power distribution center, the power module including a plurality of output drivers, each of the plurality of output drivers being in communication with a corresponding one of the plurality of controlled components;
a user interface configured to receive voice commands from a user;
a memory including instructions for responding to received voice commands; and
a processor coupled to the user interface and the memory and configured to execute the instructions in response to the received voice commands by providing at least one command to the power module to provide an activation signal via one or more of the plurality of output drivers to a corresponding one or more of the plurality of controlled components.

2. The control system of claim 1, wherein the user interface includes one or more microphones for receiving the voice commands.

3. The control system of claim 1, wherein the controller is configured to operate in a stand by mode, wherein the user interface listens for a wake-up word from the user, the controller being configured to respond to a wake-up word by entering a control mode.

4. The control system of claim 3, wherein the wake-up word is configured by the user.

5. The control system of claim 3, wherein the user interface is configured to only receive voice commands when the controller is in the control mode.

6. The control system of claim 1, further comprising a remote interface in communication with the controller, the remote interface being configured to receive voice commands from the user.

7. The control system of claim 6, wherein the remote interface is in communication with the controller over a short-range wireless connection.

8. The control system of claim 1, further comprising a brake light sensor coupled to the controller, the brake light sensor being configured to respond to detection of power to a brake light of the vehicle by providing a signal to the controller which causes the controller to disable activation of at least one of the plurality of controlled components.

9. The control system of claim 9, wherein the user interface includes a button that permits the user to re-enable activation of the at least one of the plurality of controlled components.

10. The control system of claim 1, wherein the plurality of controlled components includes at least two of a slide out, an awning, a water pump, a water heater, an HVAC system, a door lock and a plurality of lights.

11. The control system of claim 1, further comprising a plurality of monitored components of the vehicle, the controller being in communication with the plurality of monitored components and configured to receive information from the plurality of monitored components, the user interface being configured to display the information to the user.

12. The control system of claim 11, wherein the information relates to a status and/or an operational parameter of at least one of the plurality of monitored components.

13. The control system of claim 11, wherein the plurality of monitored components includes at least two of a fresh water tank, a black water tank, a gray water tank, a tire pressure sensor, a propane tank, a battery, an AC power input, an interior thermostat and an exterior thermostat.

14. The control system of claim 1, wherein the user interface further includes a speaker, the controller being configured to respond to received voice commands by providing information to the user via the speaker.

15. The control system of claim 1, wherein the plurality of controlled components includes a plurality of lights, the controller being configured to permit the user to define a plurality of lighting scenes, each lighting scene corresponding to at least one of a color or intensity setting of each of the plurality of lights.

16. The control system of claim 15, wherein the controller is configured to permit the user to control a set of lights of the plurality of lights by providing a voice command corresponding to a name of the set of lights.

17. A self-contained, voice-controlled system for a vehicle, comprising:
a control panel having a first microphone for receiving voice commands from a user;
a remote interface in communication with the control panel, the remote interface having a second microphone for receiving voice commands from the user; and
a power module in communication with the control panel and configured to provide an activation signal to a controlled component of the vehicle in response to receipt of a valid voice command from the user;
wherein a processor of the control panel determines whether a received voice command is a valid voice command by accessing instructions stored on a memory of the control panel.

18. The self-contained, voice-controlled system of claim 17, further comprising a brake light sensor coupled to the control panel, the brake light sensor being configured to respond to detection of power to a brake light of the vehicle by providing a signal to the control panel which causes the processor to prevent the power module from providing the activation signal to the controlled component.

19. The self-contained, voice-controlled system of claim 17, wherein the control panel is configured to operate in a stand by mode, wherein the control panel listens for a wake-up word from the user, the controller being configured to respond to a wake-up word by entering a control mode.

20. A system for controlling the operation of components of a vehicle, comprising:
a controller in communication with a plurality of controlled components of the vehicle, the controller including a user interface configured to receive voice commands from a user, and a processor coupled to the user interface and configured to respond to the received voice commands by causing the controller to provide an activation signal to at least one of the plurality of controlled components; and
a brake light sensor coupled to the controller, the brake light sensor being configured to respond to detection of power to a brake light of the vehicle by providing a signal to the controller which causes the processor to disable activation of at least one of the plurality of controlled components.
